(19) United States
(12) Patent Application Publication
(10) Pub. No.: US 2015/0242971 A1
(43) Pub. Date: Aug. 27, 2015

(54) Selecting Deliverables and Publishing Deliverable Checklists

(71) Applicant: Bank of America Corporation, Charlotte, NC (US)

(72) Inventors: Claudette Girard, Englewood, FL (US); Maria J. Baker, Fort Mill, SC (US); George A. Gates, Gastonia, NC (US)

(21) Appl. No.: 14/697,828

(22) Filed: Apr. 28, 2015

Related U.S. Application Data
(63) Continuation of application No. 13/206,155, filed on Aug. 9, 2011.

(51) Int. Cl. G06Q 50/16; G06Q 50/08; G06Q 10/06

(52) U.S. Cl. CPC G06Q 50/165; G06Q 10/0635; G06Q 50/08

(57) ABSTRACT

Methods, computer readable media, and apparatuses for aligning project deliverables with project risks are presented. According to one or more aspects, an architectural assessment of a new project may be received at an initial estimation phase of the new project. Subsequently, a rigor worksheet for the new project may be received at the initial estimation phase of the new project. A rigor score for the new project then may be calculated based on the architectural assessment and the rigor worksheet. Thereafter, one or more project deliverables to be imposed on the project may be selected based on the calculated rigor score.

### CROSS-REFERENCE TO RELATED APPLICATIONS

This application claims the benefit of and is a continuation of U.S. patent application Ser. No. 13/206,155, filed Aug. 9, 2011, and entitled “Aligning Project Deliverables with Project Risks,” which is incorporated by reference herein in its entirety.

### TECHNICAL FIELD

One or more aspects of the disclosure generally relate to computing devices, computing systems, and computer software. In particular, one or more aspects of the disclosure generally relate to computing devices, computing systems, and computer software that may be used by an organization, such as a financial institution, or other entity in aligning project deliverables with project risks.

### BACKGROUND

In many large organizations, a sizable number of projects may continuously be proposed by various development teams. In order to effectively manage the development and deployment of such projects, an organization, such as a financial institution, may require that each project meet certain deliverables so as to enable the status of the project to be monitored and the risk associated with developing and deploying the project to be managed. Aspects of this disclosure provide more convenient and more functional ways of managing projects such as these.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to aligning project deliverables with project risks. In particular, by implementing one or more aspects of the disclosure, an organization, such as a financial institution, may be able to assess the level of risk associated with a newly proposed project, determine that a particular amount of control and/or oversight should be applied to the development and deployment of the project (e.g., so as to obtain an optimal balance between the project's level of risk and the resources expended in controlling and overseeing the project), and subsequently apply that optimal amount of control and/or oversight by monitoring the project through its development and deployment.

According to one or more aspects, an architectural assessment of a new project may be received at an initial estimation phase of the new project. Subsequently, a rigor worksheet for the new project may be received at the initial estimation phase of the new project (e.g., once the new project becomes active in a project pipeline). A rigor score for the new project then may be calculated based on the architectural assessment and the rigor worksheet. Thereafter, one or more project deliverables to be imposed on the project may be selected and/or defined based on the calculated rigor score.

In one or more additional arrangements, the architectural assessment may take into account one or more project complexity factors and one or more customer impact factors. Additionally or alternatively, the rigor worksheet may take into account one or more project cost factors, one or more project complexity factors, one or more customer impact factors, one or more risk factors, and one or more project benefit factors.

According to one or more additional aspects, a revised architectural assessment of the new project may be received at an analyze phase of the new project. In addition, a revised rigor worksheet for the new project also may be received at the analyze phase of the new project. Subsequently, a revised rigor score for the new project may be calculated based on the revised architectural assessment and the revised rigor worksheet. It then may be determined, based on the revised rigor score, whether to continue to impose the one or more previously selected project deliverables (e.g., or whether to define and/or impose a new set of project deliverables on the project).

According to one or more additional aspects, an oversight worksheet for the new project may be received at each phase of the new project after the initial estimation phase. Then, with respect to a current phase of the new project, it may be determined, based on the oversight worksheet, whether the one or more selected project deliverables have been satisfied.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented.

FIG. 1B illustrates another example operating environment in which various aspects of the disclosure may be implemented.

FIG. 2 illustrates an example method of aligning project deliverables with project risks according to one or more illustrative aspects described herein.

FIG. 3 illustrates an example of a project development timeline according to one or more illustrative aspects described herein.

FIGS. 4A and 4B illustrate an example of a rigor tool document lifecycle according to one or more illustrative aspects described herein.

FIG. 5 illustrates an example user interface via which an architectural assessment may be received according to one or more illustrative aspects described herein.

FIG. 6 illustrates an example user interface via which a rigor worksheet may be received according to one or more illustrative aspects described herein.

FIG. 7 illustrates an example user interface via which an oversight worksheet may be received according to one or more illustrative aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

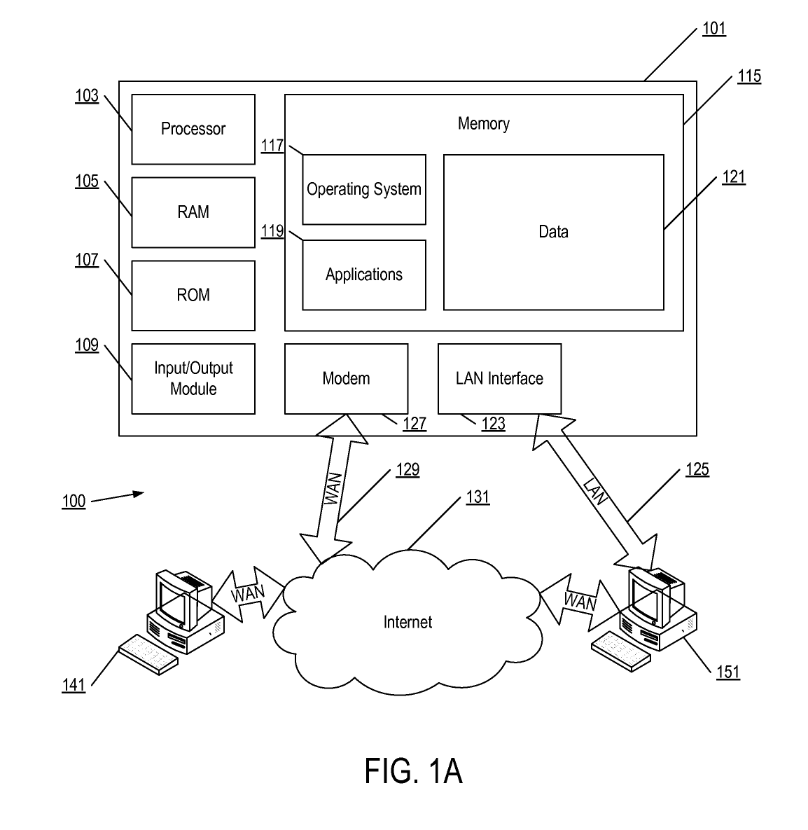

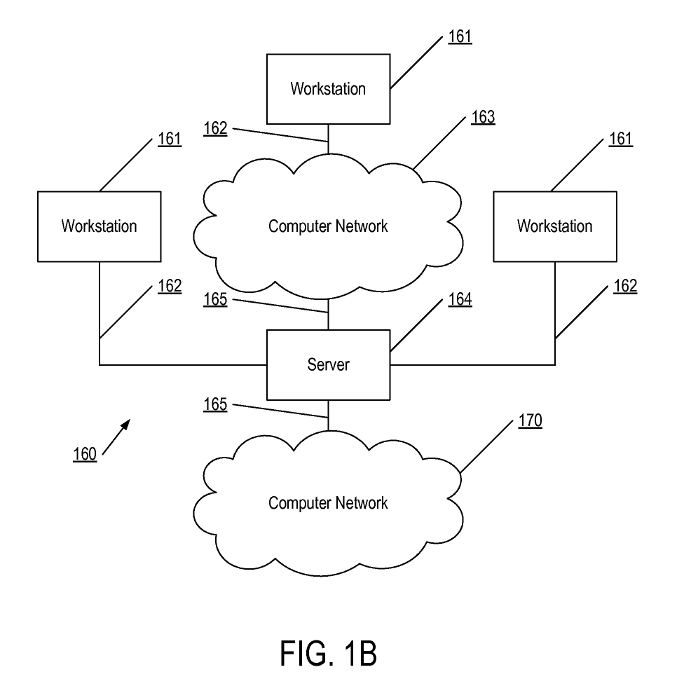

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and the like) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and the like.

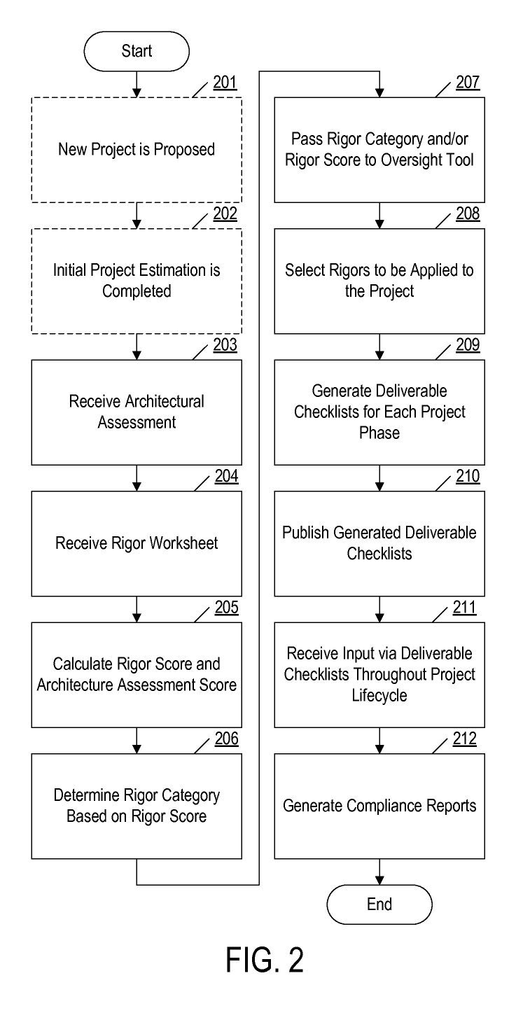

FIG. 2 illustrates an example method of aligning project deliverables with project risks according to one or more illustrative aspects described herein. According to one or more aspects, the methods described herein may be implemented by software executed on one or more computers, such as the generic computing device 101 of FIG. 1A, and/or by a computing system, such as system 160 of FIG. 1B. In at least one arrangement, the methods described herein may be performed by and/or in combination with a server (e.g., server 164). Additionally or alternatively, the methods described herein may be performed by and/or in combination with one or more workstations (e.g., workstations 161).

In step 201, a new project may be proposed. For example, in step 201, one or more entities (e.g., one or more individual employees, one or more project teams, or the like) within an organization, such as a financial institution, may propose a new project, such as a data analysis project that includes one or more data source operations (e.g., loading raw data from one or more source data sets, such as historical transaction information corresponding to a particular period of time, like the previous month or year), data manipulation operations (e.g., analyzing the raw data and computing one or more desired results, for instance, using one or more mathematical formulae and/or functions, quantitative models, regressions, or the like), and/or result loading operations (e.g., storing the computed results in one or more data tables, such as target tables, within a database and/or a data warehouse). In many arrangements, when a new project is first proposed by a project team (e.g., a project technical delivery lead (TDL), who may function as a project manager, for instance), the data source operations and/or the data manipulation operations might not, at that point in time, be defined. Rather, it may be the case that one or more particular outputs are desired and thus a project proposal might only include one or more proposed result loading operations. For instance, a project team within a particular business unit of a financial institution may propose a new data analysis project, such as a project that will involve developing one or more metrics and/or models that will allow the financial institution to identify and/or make predictions about one or more particular types of transactions completed by one or more particular types of accountholders (e.g., the number and/or average monetary amount of grocery purchases at a particular chain of retail stores by “gold” credit card accountholders for the past six months and/or predicted for the next six months).

In at least one arrangement, when a new project is proposed, an entry corresponding to the new project may be created within a database or data table of a project management system, and various pieces of information about the new project may be stored in the database or data table. For instance, the project team may propose the new project to a project management group, and the project team and/or the project management group may interact with the project management system to capture and record the information that is known about the new project at that point in time.

In step 202, an initial project estimation may be completed. For example, in step 202, the project team may develop and complete an initial project estimation that includes a preliminary development and implementation plan for the project, a proposed timeline, a list of resources that may be needed to develop and implement the project, a list of business requirements that the project may need to satisfy, a list of desired outputs to be generated and/or produced by the project, and/or other information related to the project. Additionally or alternatively, other individuals and/or teams may assess various aspects of the project at this stage, such as one or more data architects, software release coordinators, and/or the like. Furthermore, information included in the completed initial project estimation, such as the preliminary development and implementation plan, the proposed timeline, and so on, may be stored in the project management system (e.g., in a database or one or more data tables in which information about project is stored), so as to enable centralized management and maintenance of information related to the project.

In step 203, an architectural assessment may be received. For example, in step 203, a computing device (e.g., the financial institution's project management system) may receive an architectural assessment of the project. According to one or more aspects, the architectural assessment may be an electronic form that includes a plurality of questions of various categories and sub-categories, where each of the plurality of questions assesses different characteristics of the newly proposed project. In at least one arrangement, the architectural assessment may be created and/or received by the project management system as a spreadsheet file. Additionally or alternatively, the architectural assessment may be completed by one or more project architects, who may be members of a project management team or department within the organization that may specialize in assessing development and deployment needs of new projects. In one or more arrangements, the architectural assessment may be received during an initial estimation phase of the project (e.g., during a “define” phase of a project, in which one or more business requirements and/or other specifications for the project may be developed, and which may precede subsequent development and/or deployment phases of the project, such as a “measure” phase, an “analyze” phase, an “improve” phase, and/or a “control” phase, as further described below, for instance).

According to one or more aspects, the architectural assessment may be used in calculating an architecture assessment score, where the architecture assessment score may determine (or be used in determining) what type of architectural engagement model may be desired in managing development and deployment of the project. The architecture assessment score may be calculated (e.g., by the project management system) based on the selections made in the architectural assessment, and various predetermined values may be assigned to different selections corresponding to the various categories and sub-categories of questions included in the architectural assessment. Additionally or alternatively, different categories and sub-categories may be weighted, such that some characteristics of the project may affect the architecture assessment score to a greater or lesser degree than other characteristics of the project. In at least one arrangement, a predetermined threshold may be provided for the architecture assessment score, such that if the calculated architecture assessment score is less than a predetermined amount (e.g., 40), a standard architecture engagement model may be selected for use, whereas if the calculated architecture assessment score is greater than or equal to a predetermined amount (e.g., 40), a full architecture engagement model may be selected for use. In a standard architecture engagement model, for instance, an architect may approve performance metrics to ensure runtime performance, whereas in a full architecture engagement model, the architect may likewise approve performance metrics but may also create a Conceptual Solution Architecture Definition (CSAD) and provide approval for the data model associated with the project. Additional thresholds may be provided to correspond to different architecture engagement models as desired.

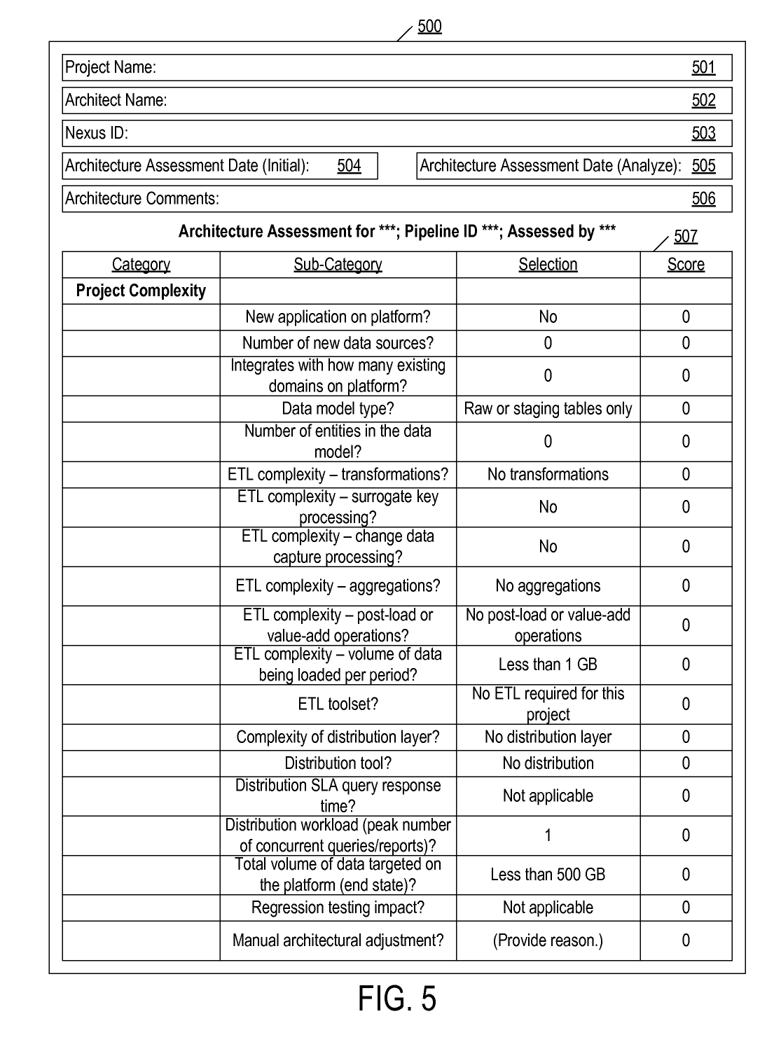

FIG. 5 illustrates an example user interface via which an architectural assessment may be received according to one or more illustrative aspects described herein. According to one or more aspects, any and/or all of the example user interfaces described herein may be displayed by and/or may be caused to be displayed by a computing device, such as a financial institution's project management system. For example, as seen in FIG. 5, user interface 500 may include various fields and regions 501, 502, 503, 504, 505, 506, and 507 in which information may be entered by a user and subsequently received by a computing device (e.g., the financial institution's project management system). In particular, user interface 500 may include a project name field 501 in which the name of the project may be entered, an architect name field 502 in which the one or more project architects performing the architectural assessment may enter their names, a nexus identifier field 503 in which a unique identifier (e.g., a string of alphanumeric characters) for the project may be entered, and an initial architecture assessment date field 504 in which the date on which the first architectural assessment of the project is completed may be entered. Additionally or alternatively, user interface 500 may include an analyze-phase architecture assessment date field 505, as in some arrangements, a second architectural assessment of the project may later be completed during an “analyze” phase of the project (e.g., during which a project's satisfaction of and/or compliance with one or more business requirements and/or other specifications for the project may be assessed and evaluated), and the date on which this second architectural assessment is completed may be entered into this analyze-phase architecture assessment date field 505. User interface 500 also may include an architecture comments field 506, in which one or more comments and/or notes related to the project may be entered (e.g., by the one or more project architects).

According to one or more aspects, user interface 500 further may include a categorical assessment region 507 in which a user, such as the one or more project architects, may enter information (e.g., by making various selections) corresponding to different categories and sub-categories of questions related to the project. As noted above, different selections may correspond to different scores, and the total score may be considered to be the architecture assessment score for the project and may be used in determining what type of architectural engagement model to select and use in managing development and deployment of the project. The following table includes example categories, sub-categories, selections, and scores corresponding to particular selections that may be included in the categorical assessment region 507 and/or that may be otherwise used in completing an architectural assessment and receiving an architectural assessment. Although various example categories, sub-categories, scoring arrangements, or the like, are shown in the table below, numerous other categories, sub-categories, scoring arrangements, or the like may be included in the assessment without departing from the disclosure. Nothing in the specification or figures should be viewed as limiting the categories, sub-categories, scoring arrangements, or the like to only those examples shown in the table.

| Category | Sub-Category | Selection | Score |
|---|---|---|---|
| Project | New Application on Platform (new supply model) | Yes | 40 |
| Complexity: | | No | 0 |
| | | Unknown | 10 |
| | Number of new Data Sources | 0 | 0 |
| | | 1 | 20 |
| | | 2 to 3 | 30 |
| | | Greater than 3 | 40 |
| | | Unknown | 10 |
| | Integrates with how many existing domains on | 0 | 0 |
| | platform? | | |
| | | 1 | 6 |
| | | 2 to 3 | 12 |
| | | Greater than 3 | 18 |
| | | Unknown | 9 |
| | Data Model Type | Raw or staging tables | 0 |
| | | only | |
| | | Snapshot(s) only | 1 |
| | | Snapshot(s) with | 2 |
| | | lookup tables | |
| | | Normalized model with | 3 |
| | | no change-data-capture | |
| | | Normalized model with | 5 |
| | | change-data-capture | |
| | | (history) | |
| | | Combination | 6 |
| | | normalized with | |
| | | snapshots and CDC | |
| | | Dimensional (Star- | 4 |
| | | Schema) model | |
| | | Dimensional (Star- | 5 |
| | | Schema) with Snow- | |
| | | flaking model | |
| | | Unknown | 3 |
| | Number of Entities in the Data Model | 0 | 0 |
| | | 1 to 4 | 1 |
| | | 5 to 10 | 2 |
| | | 11 to 20 | 3 |
| | | 20 to 50 | 4 |
| | | 50+ | 6 |
| | | Unknown | 3 |
| | ETL (Extract, Transform, and Load) Complexity - | No transformations | 0 |
| | Transformations | | |
| | | Minor transformations | 1 |
| | | Major transformations | 2 |
| | | Unknown | 1 |
| | ETL Complexity - Surrogate Key Processing? | No | 0 |
| | | Yes | 2 |
| | | Unknown | 1 |
| | ETL Complexity - Change Data Capture | No | 0 |
| | Processing? | | |
| | | Yes | 2 |
| | | Unknown | 1 |
| | ETL Complexity - Aggregations | No aggregations | 0 |
| | | Minor aggregations | 1 |
| | | Major aggregations | 2 |
| | | Unknown | 1 |
| | ETL Complexity - Post-load or Value-add | No post-load or value- | 0 |
| | operations | add operations | |
| | | Minor post-load or | 2 |
| | | value-add operations | |
| | | Major post-load or | 4 |
| | | value-add operations | |
| | | Unknown | 2 |
| | ETL Complexity - Volume of data being loaded | Less than 1 GB | 0 |
| | per period | | |
| | | 1 GB to 10 GB | 1 |
| | | 10 GB to 50 GB | 2 |
| | | Over 50 GB | 4 |
| | | Unknown | 2 |
| | ETL Tool Set | Mainframe | 3 |
| | | Data Warehouse | 2 |
| | | Platform | |
| | | IIS | 2 |
| | | SAS | 4 |
| | | ETL Platform only | 1 |
| | | Other - New tool | 12 |
| | | Other - Existing tool | 6 |
| | | No ETL required for | 0 |
| | | this project | |
| | | Unknown | 4 |
| | Complexity of Distribution Layer (L = Base | Low | 1 |
| | View, M = Some business logic/privacy/or the like; | | |
| | High = Much logic in views/denormalization in | | |
| | views, or the like) | | |
| | | Medium | 6 |
| | | High | 12 |
| | | No Distribution Layer | 0 |
| | | Unknown | 9 |
| | Distribution Tool | Existing architecture | 2 |
| | | approved BI Tool | |
| | | New architecture | 6 |
| | | approved BI Tool | |
| | | SAS | 4 |
| | | Custom-built interface | 10 |
| | | (Java or other) | |
| | | Adhoc via architecture | 1 |
| | | approved SQL tool | |
| | | No Distribution | 0 |
| | | Unknown | 4 |
| | Distribution SLA query response time | <15 seconds | 10 |
| | | 15 seconds to 1 minute | 5 |
| | | <5 minutes | 2 |
| | | 5+ minutes | 1 |
| | | Not applicable | 0 |
| | | Unknown | 4 |
| | Distribution Workload (peak # of concurrent | 1 | 0 |
| | queries/reports) | | |
| | | 2 to 3 | 6 |
| | | Greater than 3 | 12 |
| | | Unknown | 3 |
| | Total Volume of data targeted on the platform | Less than 500 GB | 0 |
| | (end state) | | |
| | | 500 GB to 2 TB | 2 |
| | | Over 2 TB | 4 |
| | | Unknown | 2 |
| | Regression Testing Impact | Not Applicable | 0 |
| | | <20% data volume | 0 |
| | | change | |
| | | 20%-100% data | 2 |
| | | volume change | |
| | | >100% data volume | 4 |
| | | change | |
| Customer | Regulatory Project, Transition or Enterprise | No | 0 |
| Impact: | Integrated Project | | |
| | | Yes | 9 |
| | Foundation | No | 0 |
| | | Yes | 9 |

Referring again to FIG. 2, in step 204, a rigor worksheet may be received. For example, after an architectural assessment is completed (e.g., by one or more project architects) and/or received (e.g., by a computing device, such as the financial institution's project management system), a computing device, such as the financial institution's project management system, may receive a rigor worksheet for the project. According to one or more aspects, the rigor worksheet may be an electronic form that includes a plurality of questions of various categories and sub-categories, where each of the plurality of questions assesses different characteristics of the new project. Like the architectural assessment described above, the rigor worksheet may be created and/or received by the project management system as part of a rigor tool document that may be a spreadsheet file. Additionally or alternatively, the rigor worksheet may be received during an initial estimation phase of the project (e.g., during a “define” phase of a project, in which one or more business requirements and/or other specifications for the project may be developed, and which may precede subsequent development and/or deployment phases of the project, such as a “measure” phase, an “analyze” phase, an “improve” phase, and/or a “control” phase, as further described below, for instance). In possible contrast to the architectural assessment described above, however, the rigor worksheet may be completed by one or more members of the project team, who may be individuals within the organization that may be directly involved in developing and deploying the subject technologies making up the new project.

According to one or more aspects, the rigor worksheet may be used in calculating a rigor score for the project, where the rigor score may determine (or be used in determining) how many rigors and/or what types of rigors may be applied to the development and deployment of the project. A “rigor” may be any type of control applied to a project, such as one or more deliverables that the project and/or the project team might be required to satisfy during development and deployment of the project. For example, an estimation workbook, a project charter, and a vendor statement of work may be examples of rigors applied to a project. In at least one arrangement, different rigors may be applied to the project during different phases of the project, and by implementing one or more aspects of the disclosure, the number and/or type of rigors to be applied to a project may be closely tailored so as to obtain and maintain an optimal level of control over a project based, for instance, on the complexity and/or amount of risk associated with the project. For example, it may be desirable to apply a relatively large number of rigors to a relatively large and/or risky project, as this may allow an organization, such as a financial institution, to better control the project and/or comply with other requirements, such as auditing requirements. On the other hand, it may be desirable to apply a relatively small number of rigors to a relatively small and/or less risky project, as this may prevent the organization from overburdening a project team and/or slowing down development of a project that might not require the heightened level of oversight given to larger projects.

According to at least one aspect, the rigor score may be calculated (e.g., by the project management system) based on the selections made in the rigor worksheet, and various predetermined values may be assigned to different selections corresponding to the various categories and sub-categories of questions included in the rigor worksheet. Additionally or alternatively, different categories and sub-categories may be weighted, such that some characteristics of the project may affect the rigor score to a greater or lesser degree than other characteristics of the project. In at least one arrangement, different score levels may be provided, such that the number and/or types of rigors to be applied to the project may depend on the particular score level in which the rigor score falls.

For example, if the calculated rigor score is greater than or equal to a first amount (e.g., 50), it may be determined that the project falls within a “high risk/peer review required” rigor category, which may dictate that a first set of rigors is to be applied to the project. If the calculated rigor score is less than the first amount (e.g., 50) but greater than or equal to a second amount (e.g., 35), it may be determined that the project falls within a “large” rigor category, which may dictate that a second set of rigors (e.g., different from the first set of rigors) is to be applied to the project. If the calculated rigor score is less than the second amount (e.g., 35) but greater than or equal to a third amount (e.g., 20), it may be determined that the project falls within a “medium” rigor category, which may dictate that a third set of rigors (e.g., different from the first and second sets of rigors) is to be applied to the project. If the calculated rigor score is less than the third amount (e.g., 20), it may be determined that the project falls within a “small” rigor category, which may dictate that a fourth set of rigors (e.g., different from the first, second, and third sets of rigors) is to be applied to the project. Additional or fewer score levels may be provided to correspond to different rigor categories, and the different rigor categories may correspond to different sets of rigors, as desired. Additionally or alternatively, one or more different sets of rigors may overlap in scope, as one or more standard rigors may, for example, apply to projects of all rigor categories. For instance, one or more rigors included in the first set of rigors also may be included in the second, third, and/or fourth set of rigors.

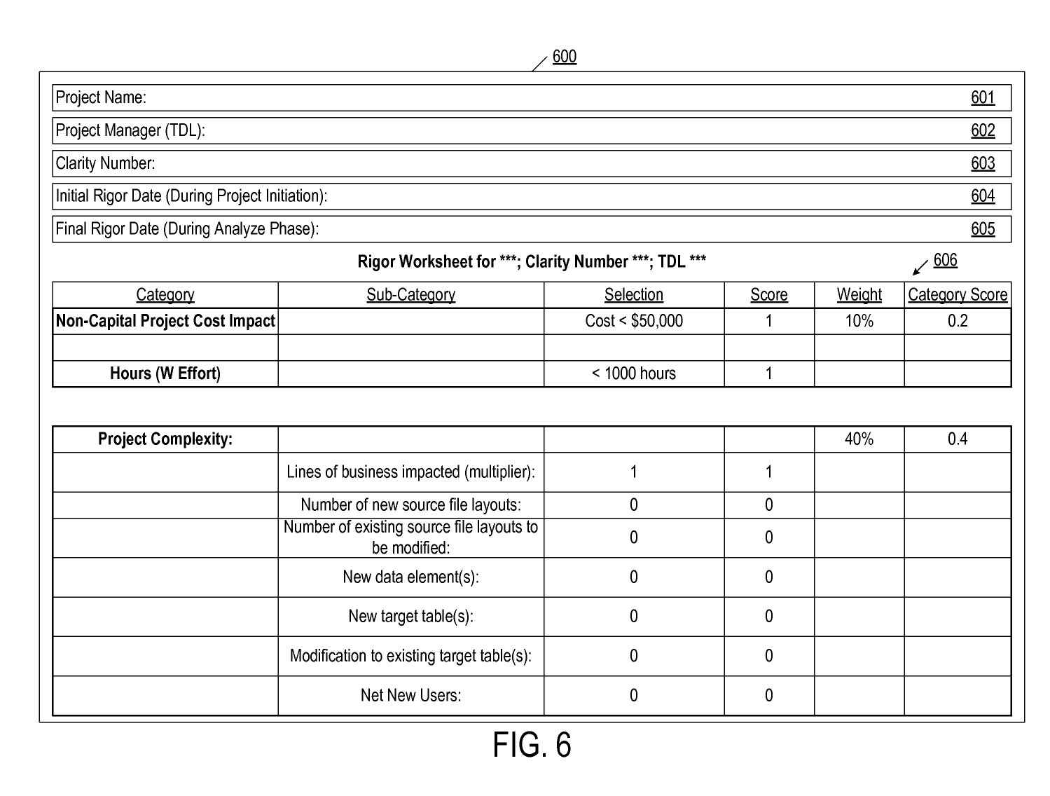

FIG. 6 illustrates an example user interface via which a rigor worksheet may be received according to one or more illustrative aspects described herein. For example, as seen in FIG. 6, user interface 600 may include various fields and regions 601, 602, 603, 604, 605, and 606 in which information may be entered by a user and subsequently received by a computing device (e.g., the financial institution's project management system). In particular, user interface 600 may include a project name field 601 in which the name of the project may be entered, a TDL field 602 in which the TDL for the project may be entered, a clarity number field 603 in which a clarity identifier (e.g., a unique or non-unique string of alphanumeric characters used with a system for internally tracking effort and/or time) for the project may be entered, and an initial rigor date field 604 in which the date on which the first rigor worksheet for the project is completed may be entered. In some instances, a plurality of projects may use or otherwise be associated with the same clarity identifier. Additionally or alternatively, user interface 600 may include a final rigor date field 605, as in some arrangements, a second rigor worksheet for the project may later by completed during an “analyze” phase of the project, and the date on which this second rigor worksheet is completed may be entered into this final rigor date field 605.

According to one or more aspects, user interface 600 further may include a categorical assessment region 606 in which a user, such as the one or more members of the project team, may enter information (e.g., by making various selections) corresponding to different categories and sub-categories of questions related to the project. As noted above, different selections may correspond to different scores, and the total score may be considered to be the rigor score for the project and may be used in determining a rigor category for the project and/or a corresponding set of rigors to be applied to the project, e.g., during the development and deployment of the project. The following table includes example categories, sub-categories, selections, scores, and weights corresponding to particular selections that may be included in the categorical assessment region 606 and/or that may be otherwise used in completing a rigor worksheet and receiving a rigor worksheet. Although various example categories, sub-categories, scoring arrangements, or the like, are shown in the table below, numerous other categories, sub-categories, scoring arrangements, or the like may be included in the assessment without departing from the disclosure. Nothing in the specification or figures should be viewed as limiting the categories, sub-categories, scoring arrangements, or the like to only those examples shown in the table.

| Category | Sub-Category | Selection | Score | Weight |
|---|---|---|---|---|
| Non-Capital | | Non-Capital Project Cost | 9 | 10% |
| Project Cost | | >$250,000 | | |
| Impact: (W | | | | |
| Effort) | | | | |
| | | Non-Capital Project Cost | 3 | |
| | | >=$50,000 & <=$250,000 | | |
| | | Non-Capital Project Cost | 1 | |
| | | <$50,000 | | |
| Hours (W | | <1000 hours | 1 | |
| Effort) | | | | |
| | | >=1000 hours and <3000 | 2 | |
| | | hours | | |
| | | >=3000 hours and <5000 | 3 | |
| | | hours | | |
| | | >=5000 hours and <10000 | 4 | |
| | | hours | | |
| | | >=10000 hours and <50000 | 5 | |
| | | hours | | |
| | | >=50000 hours | 6 | |
| Project | | | | 40% |
| Complexity: | | | | |
| | Lines of Business Impacted | 1 | 1 | |
| | (multiplier) | | | |
| | | 2 to 3 | 1.5 | |
| | | Greater than 3 | 2 | |
| | Number of new Source File Layouts. | 0 | 0 | |
| | | 1 | 6 | |
| | | 2 to 3 | 12 | |
| | | Greater than 3 | 18 | |
| | | Unknown | 9 | |
| | Number of existing Source File | 0 | 0 | |
| | Layouts to be modified | | | |
| | | 1 | 1 | |
| | | 2 to 3 | 3 | |
| | | Greater than 3 | 5 | |
| | | Unknown | 2 | |
| | New Data Element(s) | 0 | 0 | |
| | | Less than 25 | 3 | |
| | | 25-50 | 6 | |
| | | 51-150 | 12 | |
| | | Greater than 150 | 18 | |
| | | Unknown | 10 | |
| | New Target Tables | 0 | 0 | |
| | | 1 | 3 | |
| | | 2 to 3 | 6 | |
| | | 4 to 7 | 9 | |
| | | 8 to 15 | 12 | |
| | | Greater than 15 | 20 | |
| | | Unknown | 6 | |
| | Modification to Existing Target Tables | 0 | 0 | |
| | | 1 | 1 | |
| | | 2 to 3 | 3 | |
| | | 4 to 7 | 6 | |
| | | 8 to 15 | 9 | |
| | | Greater than 15 | 12 | |
| | | Unknown | 3 | |
| | Additional Data Volume being loaded | Less than 1 GB | 0 | |
| | per period | | | |
| | | 1 GB to 10 GB | 5 | |
| | | 10 GB to 50 GB | 15 | |
| | | Over 50 GB | 30 | |
| | | Unknown | 15 | |
| | Additional Data Volume % being | Less than 1% | 0 | |
| | loaded per period | | | |
| | | 1% to 10% | 0 | |
| | | 11% to 50% | 0 | |
| | | 51% to 100% | 0 | |
| | | 100% to 199% | 0 | |
| | | 200% to 299% | 0 | |
| | | Over 300% | 0 | |
| | | Unknown | 0 | |
| | Anticipated % data volume growth | Less than 1% | 0 | |
| | over the next 6 months | | | |
| | | 1% to 10% | 0 | |
| | | 11% to 50% | 0 | |
| | | 51% to 100% | 0 | |
| | | 100% to 199% | 0 | |
| | | 200% to 299% | 0 | |
| | | Over 300% | 0 | |
| | | Unknown | 0 | |
| | New Value Added Process | 0 | 0 | |
| | | 1 | 6 | |
| | | 2 to 3 | 12 | |
| | | 4 to 7 | 15 | |
| | | 8 to 15 | 18 | |
| | | Greater than 15 | 21 | |
| | | Unknown | 9 | |
| | Create New Distribution | 0 | 0 | |
| | Views/Extracts | | | |
| | | 1 | 3 | |
| | | 2 to 6 | 12 | |
| | | 7 to 15 | 18 | |
| | | Greater than 15 | 21 | |
| | | Unknown | 9 | |
| | Modify Existing Distribution | 0 | 0 | |
| | Views/Extracts | | | |
| | | 1 | 1 | |
| | | 2 to 6 | 6 | |
| | | 7 to 15 | 9 | |
| | | Greater than 15 | 12 | |
| | | Unknown | 6 | |
| | Net New Users | 0 | 0 | |
| | | Unknown | 15 | |
| | | 1 to 10 | 3 | |
| | | 11 to 50 | 5 | |
| | | 51 to 200 | 10 | |
| | | 201 to 500 | 20 | |
| | | Greater than 500 | 30 | |
| | Number of additional Daily Queries 1 | None | 0 | |
| | CPU second or less | | | |
| | | Unknown | 8 | |
| | | Less than or equal to 1000 | 1 | |
| | | 1001 to 10,000 | 5 | |
| | | Greater than 10,000 | 15 | |
| | Number of Additional Daily Queries | None | 0 | |
| | greater than 1 to 5000 CPU seconds | | | |
| | | Unknown | 10 | |
| | | Less than or equal to 100 | 5 | |
| | | 101 to 250 | 10 | |
| | | Greater than 250 | 20 | |
| | Number of Additional Daily Queries | None | 0 | |
| | greater than 5000 CPU seconds | | | |
| | | Unknown | 10 | |
| | | Less than or equal to 100 | 10 | |
| | | Greater than 100 | 20 | |
| | Interactive SLA queries response time | Not Applicable | 0 | |
| | | Unknown | 10 | |
| | | Less than or equal to 20 CPU | 20 | |
| | | seconds | | |
| | | Greater than 20 CPU seconds | 10 | |
| | # of Environments Impacted | 1 | 1 | |
| | (Mainframe, Data Warehouse | | | |
| | Platform, ETL Platform) | | | |
| | | 2 | 3 | |
| | | 3 | 6 | |
| | | 4 | 9 | |
| | | Unknown | 4 | |
| Customer | | | | 20% |
| Impact | | | | |
| | Regulatory Project, Transition or | No | 0 | |
| | Enterprise Integrated Project | | | |
| | | Yes | 9 | |
| | New Enterprise Data Model | No | 0 | |
| | | Yes | 9 | |
| | Regression Testing Only | No | 9 | |
| | | Yes | 0 | |
| | Regression testing only - >10% | No | 0 | |
| | Additional volume | | | |
| | | Yes | 5 | |
| | Regression Testing only - new values | No | 0 | |
| | | Yes | 5 | |
| | Regression testing only - Others | No | 0 | |
| | | Yes | 5 | |
| | Is the Data Warehouse the Project | No | 5 | |
| | Owner? | | | |
| | | Yes | 1 | |
| Risk | | | | 20% |
| | Information Architecture Risk | No | 0 | |
| | (Examples are Foundation and/or | | | |
| | Privacy, or the like) (Major impact to | | | |
| | the platform) | | | |
| | | Yes | 30 | |
| | New Toolset Introduced? - 3rd party | No | 0 | |
| | process | | | |
| | | Yes | 30 | |
| | Data Integration Architectural Risk | No | 0 | |
| | (Enterprise Extract Translate Load | | | |
| | Process Modification) | | | |
| | | Yes | 30 | |
| | Required new Warehouse Architectural | No | 0 | |
| | design approach | | | |
| | | Yes | 30 | |
| | LOB Relationship | Very Involved/Good & | 1 | |
| | | Known Partnership | | |
| | | Moderately Involved/Known | 5 | |
| | | Partnership | | |
| | | Not very Involved/Known | 10 | |
| | | Partnership | | |
| | | Unknown LOB | 5 | |
| | Average Team Experience with | Subject Matter Expert (>3 | 1 | |
| | Domain | years) | | |
| | | Moderate knowledge (1-3 | 3 | |
| | | years) | | |
| | | Limited knowledge (6 | 6 | |
| | | months-1 year) | | |
| | | New to the Domain (<6 | 9 | |
| | | months) | | |
| | Data Warehouse Key Person | None | 0 | |
| | availability Risk | | | |
| | | Less than 5% of project work | 2 | |
| | | done by key person | | |
| | | Greater than or equal to 5% | 6 | |
| | | and less than 10% project | | |
| | | work done by key person | | |
| | | Greater than or equal to 10% | 12 | |
| | | of project work done by key | | |
| | | person | | |
| | LOB or SOR Key Person availability | None | 0 | |
| | Risk | | | |
| | | Less than 5% of project work | 2 | |
| | | done by key person | | |
| | | Greater than or equal to 5% | 6 | |
| | | and less than 10% project | | |
| | | work done by key person | | |
| | | Greater than or equal to 10% | 12 | |
| | | of project work done by key | | |
| | | person | | |
| | Project Time Frame requirements | Project schedule is adequate | 3 | |
| | | time | | |
| | | Project schedule is very | 12 | |
| | | tight, no room for error | | |
| | | Project schedule is not | 30 | |
| | | attainable | | |
| | Impact to SLA - (research Current SLA | No negative impact to SLA | 0 | |
| | performance) | | | |
| | | SLA will be negatively | 15 | |
| | | impacted but remains in | | |
| | | current window | | |
| | | SLA will be negatively | 15 | |
| | | impacted but process/job is | | |
| | | moving to a different | | |
| | | window | | |
| | | Current SLA not being met, | 15 | |
| | | SLA must be re-negotiated | | |
| | | New SLA | 15 | |
| | | Unknown | 8 | |
| Benefit | | | | 10% |
| Impact (for | | | | |
| Entire | | | | |
| Project) | | | | |
| | Reduce Expenses | Total Est. Expense | 9 | |
| | | Reduction >=$1 MM | | |
| | | Total Est. Expense | 3 | |
| | | Reduction >= $250,000 < | | |
| | | $1 MM | | |
| | | Total Est. Expense | 1 | |
| | | Reduction <$250,000 | | |
| | | None | 0 | |
| | Improve Revenue | Total Est. Revenue | 9 | |
| | | Improvement >=$1 MM | | |
| | | Total Est. Revenue | 3 | |
| | | Improvement >= $250,000 < | | |
| | | $1 MM | | |
| | | Total Est. Revenue | 1 | |
| | | Improvement <$250,000 | | |
| | | None | 0 | |
| | Avoid Incremental Cost | Total Est. Inc. Cost | 9 | |
| | | Avoidance >=$1 MM | | |
| | | Regulatory Mandate | 6 | |
| | | Total Est. Inc. Cost | 3 | |
| | | Avoidance >= $250,000 < | | |
| | | $1 MM | | |
| | | Total Est. Inc. Cost | 1 | |
| | | Avoidance <$250,000 | | |
| | | None | 0 | |

Referring again to FIG. 2, in step 205, a rigor score and an architecture assessment score may be calculated. For example, in step 205, the computing device (e.g., the financial institution's project management system) may calculate the rigor score based on the rigor worksheet, as further described above. In one or more arrangements, calculating the rigor score may include adding up the scores corresponding to the selections made with respect to each sub-category so as to obtain scores for each category, multiplying each category score by any applicable weights, and then summing the weighted category scores to obtain the rigor score. The computing device (e.g., the financial institution's project management system) may, for instance, perform this calculation automatically in response to receiving the rigor worksheet. The architecture assessment score, as described above, may be similarly calculated based on the architectural assessment (e.g., as received in step 203).

In step 206, a rigor category for the project may be determined based on the calculated rigor score. For example, as noted above, different rigor scores may correspond to different rigor categories, and depending on the rigor category within which the project's rigor score falls, a particular set of rigors may be applied to the project. Thus, in step 206, the computing device (e.g., the financial institution's project management system) may determine that one or more rigors (e.g., one or more particular deliverables and/or other controls included in a particular rigor set) are to be applied to the project based on the rigor score calculated in step 205.

Subsequently, in step 207, the determined rigor category and/or the calculated rigor score may be passed to an oversight tool. For example, in step 207, the computing device (e.g., the financial institution's project management system) may transfer the determined rigor category and/or the calculated rigor score to a user interface that includes an oversight worksheet (e.g., by auto-populating one or more fields of the oversight worksheet with the determined rigor category and/or the calculated rigor score). In some arrangements, the computing device alternatively may display the determined rigor category and/or the calculated rigor score, and a user may view the determined rigor category and/or the calculated rigor score and enter the same into an oversight worksheet (e.g., which the computing device then may receive as user input).

According to one or more aspects, an oversight tool may be used by an organization, such as a financial institution, to track the development and deployment of a new project, for instance, by measuring and monitoring the new project's satisfaction of one or more rigors. For example, the oversight tool may measure and monitor the project's satisfaction of the one or more rigors included in the set of rigors associated with the previously determined rigor category and/or the previously calculated rigor score for the project. Additionally or alternatively, the oversight tool may include one or more oversight worksheets that each includes one or more deliverable checklists, as further described below. In one or more arrangements, the one or more oversight worksheets that make up the oversight tool may be stored in the form of an electronic spreadsheet file.

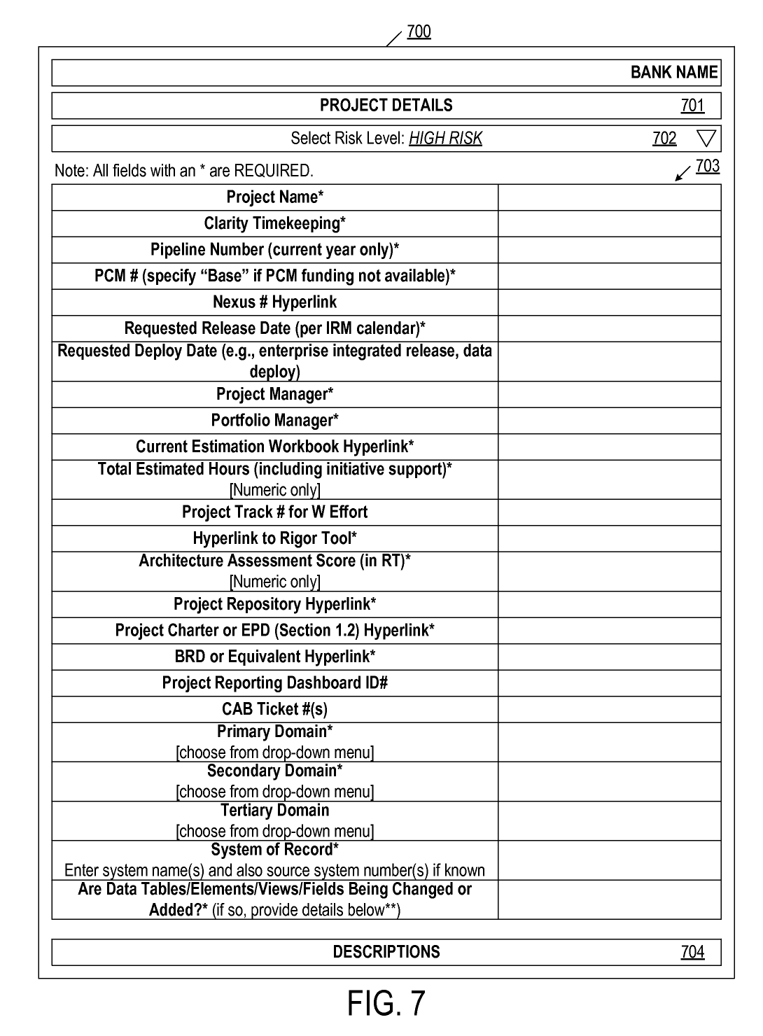

FIG. 7 illustrates an example user interface via which an oversight worksheet may be received according to one or more illustrative aspects described herein. For example, as seen in FIG. 7, user interface 700 may include various fields and regions 701, 702, 703, and 704 in which various information may be displayed to and/or entered by a user and subsequently received by a computing device (e.g., the financial institution's project management system). In particular, user interface 700 may include a project details region 701 under which one or more fields and/or controls may be displayed. For instance, project details region 701 may include a rigor category menu 702 via which a user may select a rigor category associated with the project. As noted above, in some arrangements, the rigor category menu 702 may be auto-populated, by the computing device (e.g., the financial institution's project management system), to include the rigor category previously determined (e.g., in step 206).

According to one or more aspects, project details region 701 of user interface 700 further may include a plurality of project detail fields 703 via which a user may enter, and/or via which the computing device may receive, various information about the project. Additionally or alternatively, the number and/or types of fields included in the plurality of project detail fields 703 may vary with the rigor category of the project, as selected via the rigor category menu 702. For example, if a “high risk” rigor category is selected via the rigor category menu 702, then a relatively large number of fields may be included in the plurality of project detail fields 703, whereas if a lesser rigor category, such as a “small” rigor category is selected via the rigor category menu 702, then a relatively small number of fields may be included in the plurality of project detail fields 703. In at least one arrangement, user interface 700 also may include one or more additional regions, such as a descriptions region 704, which may include one or more text boxes via which a user may enter additional information, such as full-text information, about the project. These one or more additional regions of user interface 700 also may include one or more deliverable checklists, which are further described below. In some instances, such deliverable checklists may be displayed on different tabs or worksheets within a single workbook, where the entire workbook may make up an oversight tool.

Referring again to FIG. 2, in step 208, one or more rigors may be selected, based on the determined rigor category and/or the calculated rigor score, to be applied to the project. For example, in step 208, the computing device (e.g., the financial institution's project management system) may select one or more rigors to be applied to the project at one or more phases of the project. For instance, the computing device may determine that a first set of rigors are to be applied to a project prior to a “define” phase of the project, that a second set of rigors are to be applied to the project during the “define” phase of the project, that a third set of rigors are to be applied to the project during a “measure” phase of the project, that a fourth set of rigors are to be applied to the project during an “analyze” phase of the project, that a fifth set of rigors are to be applied to the project during an “improve” phase of the project, and/or that a sixth set of rigors are to be applied to the project during a “control” phase of the project.

The following table includes examples of the sets of rigors that may be selected (e.g., by the computing device in step 208) to be applied in different phases with respect to different categories of projects. In particular, in the table below, various rigors are listed by project phase in the first column (e.g., “Deliverables”), and different rigor categories of projects (e.g., “Express Project Small (Tier 3),” “Express Project Medium (Tier 3),” “Standard Project Large (Tier 0-2),” “Standard Project High Risk/Peer Review,” or the like) are listed in the other columns. Among the various rigor categories of projects illustrated in the table, “Regression” and “Consulting” projects might not involve any code development, for instance, and as such, may subject to fewer deliverables than projects of other rigor categories. In addition, in the table below, an “R” indicates that the particular rigor may be required for a project of the corresponding rigor category, a “D” indicates that the particular rigor may be discretionary for a project of the corresponding rigor category (e.g., the rigor may be required depending on the project's impact on a particular and/or targeted platform), an “O” indicates that the particular rigor may be optional for a project of the corresponding rigor category, and an “N” indicates that the particular rigor might not be required for a project of the corresponding rigor category. Although various example deliverables, project phases, project types, or the like, are shown in the table below, numerous other deliverables, project phases, project types, or the like may be used without departing from the disclosure. Nothing in the specification or figures should be viewed as limiting the deliverables, project phases, project types, or the like to only those examples shown in the table.

| | | | | | | Regression | | | |
|---|---|---|---|---|---|---|---|---|---|
| | | | | Standard | | LOB signoff | | | |
| | Express | Express | Standard | Project | Regression | required | Regression | | |
| | Project | Project | Project | High | LOB | w/existing | NO LOB | | |
| | Small | Medium | Large | Risk/Peer | signoff | UAT | signoff | | Consulting |
| Deliverable | (Tier 3) | (Tier 3) | (Tier 0-2) | Review | required | Environment | required | Consulting | with Data |
| Pre-Define | | | | | | | | | |
| Estimation Workbook | R | R | R | R | R | R | R | R | R |
| Define | | | | | | | | | |
| Project Charter | R | R | R | R | R | R | R | R | R |
| | EPD 1.2 | Project | | | EPD 1.2 | EPD 1.2 | EPD 1.2 | EPD 1.2 | EPD 1.2 |
| | | Charter or | | | | | | | |
| | | EPD 1.0 | | | | | | | |
| Register Project in Pipeline | R | R | R | R | R | R | R | R | R |
| Engage with IRM | R | R | R | R | R | R | R | R | R |
| Right Fit Assessment | O | O | O | O | N | N | N | N | N |
| INITIAL RIGOR Worksheet | R | R | R | R | R | R | R | N | N |
| Estimation Workbook | R | R | R | R | R | R | R | R | R |
| SOW (Vendor Statement of | N | N | N | N | N | N | N | N | N |
| Work) | | | | | | | | | |
| PAL (Project Asset Library) | R | R | R | R | R | R | R | R | R |
| | EPD 2.2 | EPD 2.2 | | | | | | | |
| IFM Setup (Project | R | R | R | R | R | R | R | R | R |
| Financials) | | | | | | | | | |
| Project Reporting Dashboard | R | R | R | R | R | R | R | R | R |
| CAB Setup (Change Advisory | R | R | R | R | R | N | N | N | N |
| Board) | | | | | | | | | |
| IRM Project Details | R | R | R | R | R | R | R | R | R |
| Measure | | | | | | | | | |
| IRM Peer Review (specific to | N | N | N | R | N | N | N | N | N |
| High Risk Programs) | | | | | | | | | |
| BRD (Business Requirements | R | R | R | R | R | R | R | R | R |
| Doc) or Equivalent | EPD 3.0 | EPD 3.0 | | | EPD 3.0 | EPD 3.0 | EPD 3.0 | EPD 3.0 | EPD 3.0 |
| SPP (Software Project Plan) | N | N | R | R | N | N | N | N | N |
| Express Project Document | Express | Express | N | N | R | R | R | N | N |
| replaces the SPD (Small | Project | Project | | | | | | | |
| Project Document) | Document | Document | | | | | | | |
| | (EPD) R | (EPD) R | | | | | | | |
| Stakeholder Analysis | N | N | R | R | N | N | N | N | N |
| WBS (Work Breakdown | N | R | R | R | N | N | N | N | N |
| Structure) | | | | | | | | | |
| Workgroup Packet (includes | N | R | R | R | N | N | N | N | N |
| resource plan) | | EPD 2.1 | | | | | | | |
| Data Profile | O | O | O | O | N | N | N | N | N |
| | EPD 4.3 | EPD 4.3 | | | | | | | |
| Gap Analysis | O | O | O | O | N | N | N | N | N |
| | EPD 4.3 | EPD 4.3 | | | | | | | |
| CSAD (Conceptual Solutions | D | D | D | D | N | N | N | N | N |
| Architecture Doc) | | | | | | | | | |
| Traceability Matrix | N | N | R | R | N | N | N | N | N |
| Estimation Workbook | R | R | R | R | R | R | R | R | R |
| High Level Communication | D | D | R | R | N | N | N | N | N |
| Plan | EPD 2.6 | EPD 2.6 | | | | | | | |
| High Level Education Plan | D | D | D | R | N | N | N | N | N |
| | EPD 2.6 | EPD 2.6 | | | | | | | |
| IRM Measure Checkpoint | R | R | R | R | R | R | R | N | N |
| Analyze | | | | | | | | | |
| HLD (High Level Design) | R | R | R | R | R | R | R | N | N |
| | EPD 5.2 | EPD 5.2 | | | EPD 5.2 | EPD 5.2 | EPD 5.2 | | |
| FINAL RIGOR Worksheet | R | R | R | R | R | R | R | N | N |
| EPE Entry Criteria Checklist | R | R | R | R | R | R | R | N | N |
| Data Model | O | O | O | O | N | N | N | N | N |
| | EPD 5.2 | EPD 5.2 | | | | | | | |
| DDL (Data Definition | O | O | O | O | N | N | N | N | N |
| Language) | EPD 5.2 | EPD 5.2 | | | | | | | |
| LLD (Low Level Design) | R | R | R | R | R | R | R | N | N |
| | EPD 5.2 | EPD 5.2 | | | EPD 5.2 | EPD 5.2 | EPD 5.2 | | |
| EMIP Business Metadata | D | D | D | D | D | D | D | N | N |
| Upload Form | (required | (required | (required | (required | (required | (required | (required | | |
| | for new | for new | for new | for new | for new | for new | for new | | |
| | metadata) | metadata) | metadata) | metadata) | metadata) | metadata) | metadata) | | |
| EMIP Data Lineage | D | D | D | D | D | D | D | N | N |
| | (required | (required | (required | (required | (required | (required | (required | | |
| | for new | for new | for new | for new | for new | for new | for new | | |
| | metadata) | metadata) | metadata) | metadata) | metadata) | metadata) | metadata) | | |
| DEV/SIT Environment | D | D | D | D | N | N | N | N | N |
| Capacity Forecast | (required | (required | (required | (required | | | | | |
| | when | when | when | when | | | | | |
| | space is | space is | space is | space is | | | | | |
| | required | required | required | required | | | | | |
| | in Dev) | in Dev) | in Dev) | in Dev) | | | | | |
| Initiative Environment | D | D | D | D | N | N | N | N | N |
| Request (IER) | (required | (required | (required | (required | | | | | |
| | when | when | when | when | | | | | |
| | space is | space is | space is | space is | | | | | |
| | required in | required in | required | required | | | | | |
| | Dev) | Dev) | in Dev) | in Dev) | | | | | |
| Risk Management Matrix | D | R | R | R | N | N | N | N | N |
| | | EPD 2.3 | | | | | | | |
| Unit Test Plan | R | R | R | R | N | N | N | N | N |
| | EPD 6.0 | EPD 6.0 | | | | | | | |
| SIT Plan (System Integration | R | R | R | R | R | R | R | N | N |
| Test) | EPD 6.0 | EPD 6.0 | | | | | | | |
| UAT Plan (User Acceptance | R | R | R | R | R | R | N | N | N |
| Test) | EPD 6.0 | EPD 6.0 | | | | | | | |
| Test Scripts (Unit, SIT, UAT) | R | R | R | R | R | R | R | N | N |
| | EPD 6.0 | EPD 6.0 | | | | | | | |
| Traceability Matrix | N | N | R | R | N | N | N | N | N |
| Detailed Communication Plan | O | O | O | R | N | N | N | N | N |
| | EPD 2.6 | EPD 2.6 | | | | | | | |
| Detailed Education Plan | D | D | D | R | N | N | N | N | N |
| | EPD 2.6 | EPD 2.6 | | | | | | | |
| Privacy Checklist | R | R | R | R | R | R | R | N | N |
| AR Approval for Design | D | D | R | R | N | N | N | N | N |
| Estimation Workbook | R | R | R | R | R | R | R | R | R |
| Master Service Level | D | D | D | D | D | D | D | N | N |
| Agreement (SLA) Draft | | | | | | | | | |
| Draft Consolidated Load | D | D | D | D | D | D | D | N | N |
| Schedule/SLA Addendum | | | | | | | | | |
| Sheet (CLASS) | | | | | | | | | |
| ITM Signoff on Test Plan | D | D | D | D | N | N | N | N | N |
| Disaster Recovery | D | D | D | D | N | N | N | N | N |
| questionnaire | | | | | | | | | |
| Backup/Archive Strategy | D | D | D | D | N | N | N | N | N |
| Initial Review | | | | | | | | | |
| IRM Peer Review (specific to | N | N | N | R | N | N | N | N | N |
| High Risk Programs) | | | | | | | | | |
| IRM Analyze Checkpoint | R | R | R | R | R | R | R | N | R |
| Improve | | | | | | | | | |
| UAT Environment Capacity | D | D | D | D | D | D | N | N | N |
| Forecast | (required | (required | (required | (required | (required | (required | | | |
| | when | when | when | when | when | when | | | |
| | space is | space is | space is | space is | space is | space is | | | |
| | required | required | required | required | required | required | | | |
| | in UAT) | in UAT) | in UAT) | in UAT) | in UAT) | in UAT) | | | |
| Initiative Environment | D | D | D | D | D | D | N | N | N |
| Request (IER) | (required | (required | (required | (required | (required | (required | | | |
| | when | when | when | when | when | when | | | |
| | space is | space is | space is | space is | space is | space is | | | |
| | required | required | required | required | required | required | | | |
| | in UAT) | in UAT) | in UAT) | in UAT) | in UAT) | in UAT) | | | |
| UAT Environment Space | D | D | D | D | D | D | N | N | N |
| Approval | | | | | | | | | |
| DBA Turnover | D | D | D | D | D | D | N | N | N |
| Document/DDL | | | | | | | | | |
| Access Category Setup Form | D | D | D | D | D | D | N | N | N |
| and Approval | | | | | | | | | |
| Load ID Setup Form and | D | D | D | D | D | D | N | N | N |
| Approval | | | | | | | | | |
| UAT Migration Plan - (UNIX, | D | D | D | D | D | N | N | N | N |
| ETL Platform, IIS) | | | | | | | | | |
| UAT Implementation Plan - | D | D | D | D | D | N | N | N | N |
| (UNIX, ETL Platform, IIS) | | | | | | | | | |
| XML Tool Report for Code | D | D | D | D | N | N | N | N | N |
| Review - ETL Platform Only | | | | | | | | | |
| PMCP Metrics for UAT (SIT | D | D | D | D | D | N | N | N | N |
| Metrics) | | | | | | | | | |
| Link to Metadata Project | D | D | D | D | D | D | D | N | N |
| Package in EMIP | | | | | | | | | |
| AR Sign Off for UAT | D | D | R | R | D | D | N | N | N |
| (Architect approval for SIT | | | | | | | | | |
| metrics) | | | | | | | | | |
| Draft Application Control | D | D | R | R | D | D | D | N | N |
| Plan | | | | | | | | | |
| SIT Results | R | R | R | R | R | R | R | N | N |
| | EPD 6.0 | EPD 6.0 | | | | | | | |
| SIT Sign-Off | R | R | R | R | R | R | R | N | N |
| Traceability Matrix | N | N | R | R | N | N | N | N | N |
| Detailed Task Schedule (DTS) | R | R | R | R | R | R | R | N | R |
| completed | | | | | | | | | |
| Deployment Plan | D | D | R | R | N | N | N | N | N |
| Privacy Report | D | D | D | D | N | N | N | N | N |
| EIM SCRIPTS REUSE TOOL | R | R | R | R | R | R | R | N | N |
| CPO MEASUREMENT | | | | | | | | | |
| survey | | | | | | | | | |
| IRM UAT Readiness | R | R | R | R | R | R | R | N | R |
| Checkpoint | | | | | | | | | |
| Risk Management Matrix | D | R | R | R | N | N | N | N | N |
| | | EPD 2.3 | | | | | | | |
| Response to OCNI email | R | R | R | R | N | N | N | N | N |
| OCNI template | D | D | D | D | N | N | N | N | N |
| PMCP Metrics for PROD | D | D | D | D | N | N | N | N | N |
| (UAT Metrics/80% volume) | | | | | | | | | |
| Data Warehouse Platform | D | D | D | D | N | N | N | N | N |
| Production Space/Capacity | | | | | | | | | |
| Forecast | | | | | | | | | |
| CAR Form Space Request - | D | D | D | D | N | N | N | N | N |
| Removed Space Request for | | | | | | | | | |
| Prod) | | | | | | | | | |
| Prod Space Approval | D | D | D | D | N | N | N | N | N |
| UAT Results (No ITM) | R | R | R | R | R | R | N | N | N |
| | EPD 6.0 | EPD 6.0 | | | EPD 6.0 | EPD 6.0 | | | |
| UAT LOB Sign-Off (No ITM) | R | R | R | R | R | R | N | N | N |
| UAT Results (with ITM) | R | R | R | R | R | R | N | N | N |
| | EPD 6.0 | EPD 6.0 | | | | | | | |
| UAT LOB Sign-Off (with | R | R | R | R | R | R | N | N | N |
| ITM) | | | | | | | | | |
| LOB Sign-Off for Deferred | D | D | D | D | D | D | D | N | N |
| Defects | | | | | | | | | |
| Architecture Review (AR) | D | D | D | D | N | N | N | N | N |
| Sign-Off on UAT Perf Metrics | | | | | | | | | |
| Master Service Level | D | D | D | D | D | D | D | N | N |
| Agreement (SLA) Final | | | | | | | | | |
| Final Consolidated Load | D | D | D | D | D | D | D | N | N |
| Schedule/SLA Addendum | | | | | | | | | |
| Sheet (CLASS) | | | | | | | | | |
| Disaster Recovery | D | D | D | D | N | N | N | N | N |
| questionnaire sign-off | | | | | | | | | |
| Archive Strategy Sign-off | D | D | D | D | N | N | N | N | N |
| Change Request Form | D | D | D | D | D | D | D | N | N |
| Migration Plan - (UNIX, ETL | D | D | D | D | N | N | N | N | N |
| Platform, IIS) | | | | | | | | | |
| Operations Manual - (UNIX, | D | D | D | D | N | N | N | N | N |
| ETL Platform only) | | | | | | | | | |
| Implementation Plan | D | D | D | D | N | N | N | N | N |
| (Midrange I Plan) - (UNIX, | | | | | | | | | |
| ETL Platform, IIS) | | | | | | | | | |
| Maestro Autosys Document - | D | D | D | D | N | N | N | N | N |
| (UNIX, ETL Platform, IIS) | | | | | | | | | |
| XML Tool Report for Code | D | D | D | D | N | N | N | N | N |
| Review - ETL Platform Only | | | | | | | | | |
| XML Zip File - ETL Platform | D | D | D | D | N | N | N | N | N |
| Only | | | | | | | | | |
| DBA Turnover | D | D | D | D | N | N | N | N | N |
| Document/DDL | | | | | | | | | |
| ID & Database Categorization | D | D | D | D | N | N | N | N | N |
| Access Category Setup Form | D | D | D | D | N | N | N | N | N |
| and Approval | | | | | | | | | |
| Load ID Setup Form and | D | D | D | D | N | N | N | N | N |
| Approval | | | | | | | | | |
| Final Application Control Plan | D | D | R | R | D | D | D | N | N |
| EPE Signoff received | D | D | D | D | D | D | D | N | N |
| W Service Center Bulletin and | D | D | R | R | R | R | R | N | N |
| Script (Who is impacted) | | | | | | | | | |
| Privacy Report | D | D | D | D | N | N | N | N | N |
| IRM Peer Review (specific to | N | N | N | R | N | N | N | N | N |
| High Risk Programs) | | | | | | | | | |
| IRM Production Readiness | R | R | R | R | R | R | R | N | N |
| Checkpoint | | | | | | | | | |
| Control | | | | | | | | | |
| Document Lessons | O | R | R | R | O | O | O | O | O |
| Learned/Best Practices | | | | | | | | | |
| EMIP Post Deployment | D | D | D | D | N | N | N | N | N |
| Implementation | | | | | | | | | |
| Transition to Prod Support | D | D | R | R | N | N | N | N | N |
| (Creation of the Production | | | | | | | | | |
| Turnover Document) | | | | | | | | | |
| Production Turnover Sign-Off | D | D | R | R | N | N | N | N | N |
| (Production Spt signs off on | | | | | | | | | |
| Turnover Document) | | | | | | | | | |
| Project CloseOut Checklist | N | N | R | R | N | N | N | N | N |
| IRM Control Checkpoint | R | R | R | R | R | R | R | R | R |

In step 209, one or more deliverable checklists may be generated for each phase of the project. For example, in step 209, the computing device (e.g., the financial institution's project management system) may generate one or more deliverable checklists for each phase of the project based on the rigors selected in step 208. In particular, the deliverable checklist for each phase of the project may include the one or more rigors selected (e.g., in step 208) for the corresponding phase of the project.

In step 210, the one or more generated deliverable checklists may be published. For example, in step 210, the computing device (e.g., the financial institution's project management system) may publish the one or more generated deliverable checklists by electronically transmitting (e.g., via electronic mail) the deliverable checklists to the project team, one or more architects, one or more project managers and/or coordinators, and/or other interested entities. In some additional and/or alternative arrangements, the oversight tool and its one or more associated deliverable checklists may be stored in a single, central location (e.g., in a database or an enterprise file management system), and in such arrangements, the computing device may publish the deliverable checklists by electronically transmitting a link (e.g., a hyperlink) to the oversight tool, rather than sending copies of the deliverable checklists, so that all interested entities may edit, update, and/or view the same copy of the oversight tool.

In step 211, user input may be received via the generated deliverable checklists. According to one or more aspects, such user input may be received periodically throughout the lifecycle of the project. For example, in step 211, a user may complete each of the deliverable checklists included in the oversight tool in each of the various phases of the project (e.g., as time elapses through the lifecycle of the project). In addition, as the user completes each of the deliverable checklists, the information entered by the user may be received by the computing device (e.g., the financial institution's project management system), which may enable the computing device to track and/or assess the project's compliance with the deliverable checklists, and correspondingly, the project's satisfaction of the rigors selected to be applied to the project.

In step 212, one or more compliance reports may be generated. For example, in step 212, the computing device (e.g., the financial institution's project management system) may generate one or more reports that include status information about the project and/or about the project's satisfaction of the one or more rigors applied to the project based on the user input received in connection with the deliverable checklists. For instance, such a report may include the current phase of the project, whether the project has satisfied all of the rigors applied to the project up to the current phase, what rigors the project has satisfied, what rigors the project has not satisfied, and/or any other information about the project as may be desired.

Having described an example method of aligning project deliverables with project risks, several additional examples illustrating how such a method may be implemented and/or otherwise carried out will now be described.

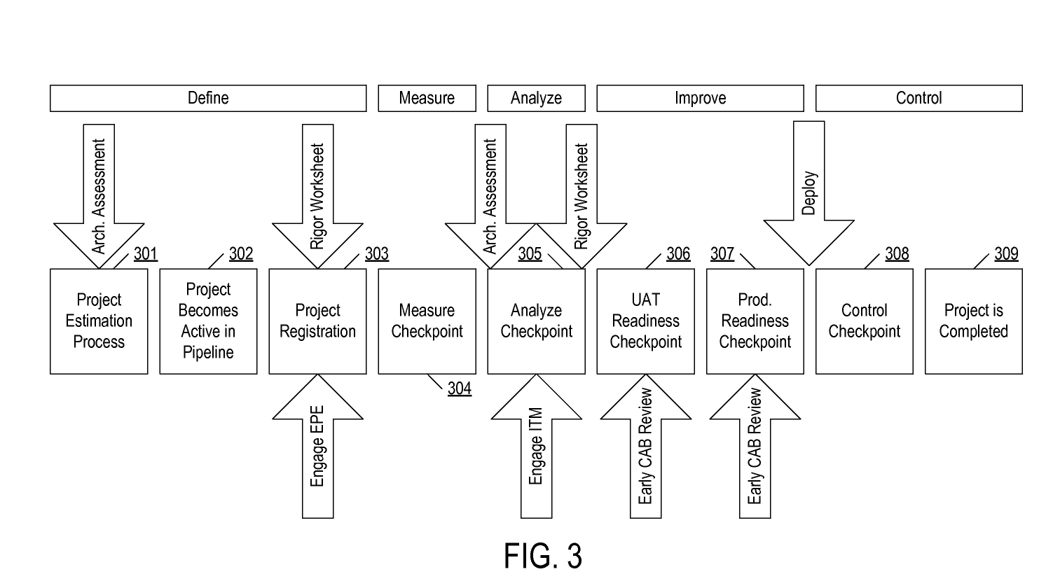

FIG. 3 illustrates an example of a project development timeline according to one or more illustrative aspects described herein. In particular, as seen in the example project timeline of FIG. 3, the first phase of a project development timeline may be a “define” phase, in which one or more aspects of the project may be determined and defined, for instance, by a project team tasked with developing and deploying the project. As illustrated, the define phase may begin with a project estimation process 301 in which various requirements and other considerations related to developing and deploying the project may be estimated. During this initial project estimation process, a first architectural assessment may be completed, as further described above. Subsequently, in the define phase, the project may become active in a pipeline of new projects 302. The pipeline of new projects may, for instance, be managed by one or more project coordinators, who may oversee the development and deployment of a plurality of different projects. Thereafter, in the define phase, the project may be registered 303, at which time the project team also may be required to submit a completed rigor worksheet, and at which time an early project engagement (EPE) team (e.g., a production support team) may be engaged.

Subsequently, the project may enter a “measure” phase, and the project may reach a measure checkpoint 304. During the measure phase, various substantive aspects of the project may be assessed, such as how well one or more prototypes and/or models of the project performed. Then, the project may enter an “analyze” phase, and the project may reach an analyze checkpoint 305. During the analyze phase, a second architectural assessment may be completed and a second rigor worksheet may be completed (or the original rigor worksheet may be updated), as further described above. Additionally or alternatively, an integrated test management (ITM) may be engaged.

Once the project passes the analyze checkpoint 305, the project may enter an “improve” phase in which various substantive aspects of the project may be improved, e.g., based on the assessments completed during the measure and analyze phases. During the improve phase, the project may reach a user acceptance testing (UAT) readiness checkpoint 306 in which various aspects of the project may be evaluated, e.g., to determine whether the project satisfies one or more user requirements and/or other requirements set forth in one or more project specifications. Additionally or alternatively, at the UAT readiness checkpoint 306, the project may be subjected to an early review by a change advisory board (CAB), which may be responsible for reviewing all new projects, e.g., to assess the project's impact on existing systems. Once the project passes the UAT readiness checkpoint 306, the project may reach a production readiness checkpoint 307 in which it may be determined whether the project is ready for deployment in a production environment (e.g., in contrast to one or more testing environments in which the project may already be deployed). Additionally or alternatively, at the production readiness checkpoint 307, the project may again be subjected to an early CAB review.

Thereafter, the project may be deployed, at which point the project may enter a “control” phase. During the control phase, various aspects of the project may be controlled, e.g., to ensure the project's performance quality and/or its continued satisfaction of various requirements. In particular, the project may reach a control checkpoint 308 in which the project's performance quality and/or its satisfaction of various requirements may be assessed (and/or any identified issues may be addressed). Subsequently, the project may be completed 309.

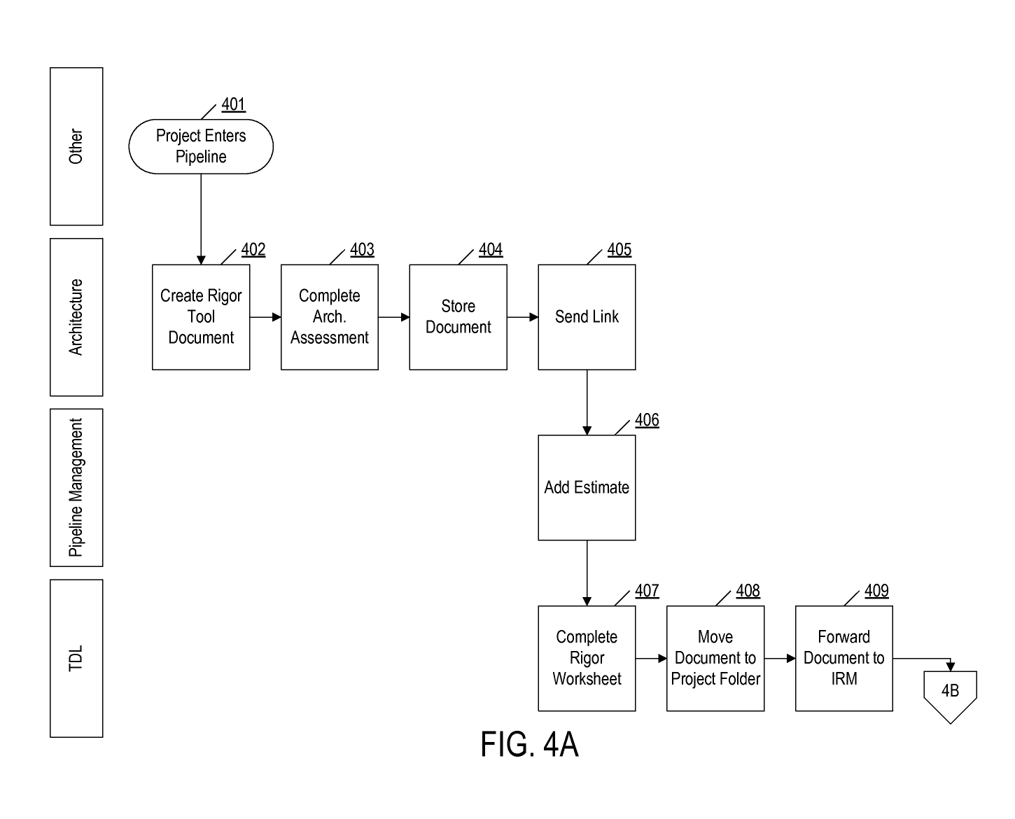

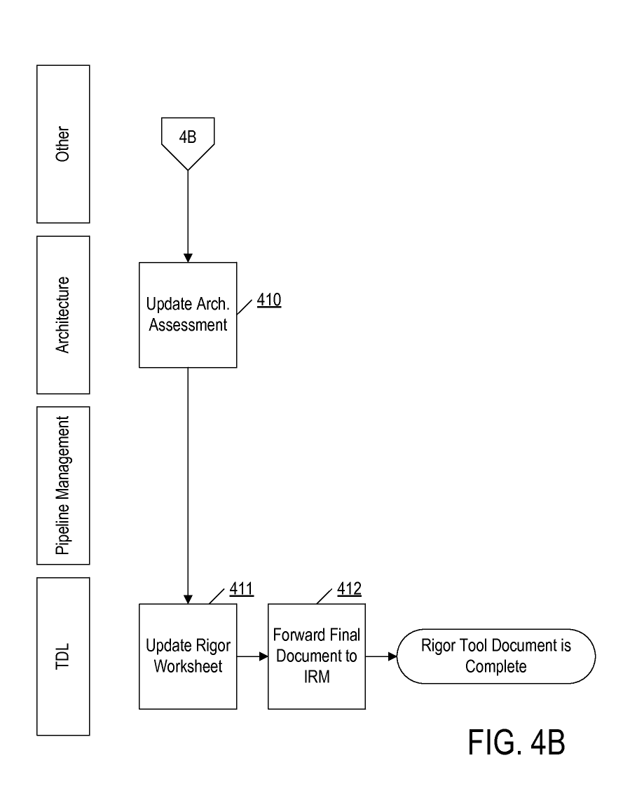

FIGS. 4A and 4B illustrate an example of a rigor tool document lifecycle according to one or more illustrative aspects described herein. In particular, the example rigor tool document lifecycle shown in these figures illustrates which groups and/or other entities within an organization, such as a financial institution, might interact with a rigor tool document (e.g., a document or computer file in which both an architectural assessment and a rigor worksheet, as described above, may be stored) at various points in time. For instance, in step 401, a new project may enter a project pipeline. Thereafter, in step 402, one or more project architects associated with an architecture group may create a rigor tool document. In step 403, the one or more architects may complete the architectural assessment (which may be stored in the rigor tool document), and in step 404, the rigor tool document may be saved. Then, in step 405, the architecture group may send a link to the rigor tool document to a project pipeline management group, which may, in step 406, add one or more estimates to the rigor tool document.

Subsequently, in step 407, the project manager (e.g., the TDL) may complete the rigor worksheet included in the rigor tool. The TDL then may move the rigor tool document to a shared project folder in step 408, and may, in step 409, forward the rigor tool document to an Integrated Release Management (IRM) group, which may coordinate and/or otherwise manage various aspects of the development and deployment of a plurality of projects. Thereafter, in step 410, the architecture group may update the architectural assessment included in the rigor tool document (e.g., when the project reaches an analyze phase, as further described above). And, in step 411, the TDL may update the rigor worksheet included in the rigor tool document (e.g., while the project is in the analyze phase, as further described above). The TDL then may forward the final rigor tool document to the IRM group in step 412, after which point the rigor tool document may be considered complete.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A computer system, comprising:
at least one processor;
at least one network interface for establishing communications between the computer system and one or more computing devices; and
memory storing computer-readable instructions that, when executed by the at least one processor, cause the computer system to:
receive an architectural assessment file, the architectural assessment file comprising an evaluation of development and deployment needs of a new project provided by one or more project architects during an initial estimation phase of the project;
calculate, based on the architectural assessment file, an architecture assessment score for the project;
select, based on the calculated architecture assessment score, an architectural engagement model to be imposed on the project at the initial estimation phase of the project,
wherein a first architectural engagement model is selected at the initial estimation phase when the calculated architecture assessment score is less than a predetermined architecture threshold, and
wherein a second architectural engagement model is selected at the initial estimation phase when the calculated architecture assessment score is greater than or equal to the predetermined architecture threshold;
receive a rigor worksheet file, the rigor worksheet file comprising an evaluation of risks and impact of the project provided by one or more members of a project team associated with the project during the initial estimation phase of the project;
calculate, based on the rigor worksheet file, a rigor score for the project;
determine, based on the calculated rigor score, a corresponding rigor category for the project;
select, based on the determined rigor category, one or more project deliverables to be imposed on the project at the initial estimation phase of the project;
generate one or more deliverable checklists based on the one or more project deliverables selected to be imposed on the project at the initial estimation phase of the project;
store, using the at least one network interface, the one or more deliverable checklists in a database associated with an enterprise file management system provided by at least one computing device different from the computer system; and
publish the one or more deliverable checklists by electronically transmitting one or more links to the one or more deliverable checklists to one or more entities.

2. The computer system of claim 1, wherein the architectural assessment file takes into account one or more project complexity factors and one or more customer impact factors.

3. The computer system of claim 1, wherein the rigor worksheet file takes into account one or more project cost factors, one or more project complexity factors, one or more customer impact factors, one or more risk factors, and one or more project benefit factors.

4. The computer system of claim 1, wherein the memory stores additional computer-readable instructions that, when executed by the at least one processor, further cause the computer system to:
receive a revised architectural assessment file, the revised architectural assessment file comprising an evaluation of development and deployment needs of the project provided by one or more project architects during an analyze phase of the project, wherein the initial estimation phase of the project precedes the analyze phase of the project;
calculate, based on the revised architectural assessment file, a revised architecture assessment score for the project;
determine, based on the revised architecture assessment score, whether to continue to impose the previously selected architecture engagement model;
receive a revised rigor worksheet file, the revised rigor worksheet file comprising an evaluation of risks and impact of the project provided by one or more members of a project team associated with the project during the analyze phase of the project;
calculate, based on the revised rigor worksheet file, a revised rigor score for the project;
determine, based on the revised rigor score, a revised rigor category for the project; and
determine, based on the revised rigor category, whether to continue to impose the one or more previously selected project deliverables.

5. The computer system of claim 1, wherein the rigor score represents an objective measure of risk associated with the project.

6. The computer system of claim 1, wherein the memory stores additional computer-readable instructions that, when executed by the at least one processor, further cause the computer system to:
receive an oversight worksheet file for the project at each phase of the project after the initial estimation phase; and
determine, based on the oversight worksheet file, whether the one or more selected project deliverables have been satisfied for a current phase of the project.

7. The computer system of claim 1,
wherein the rigor worksheet file comprises one or more categories, and
wherein calculating the rigor score for the project comprises:
adding, for each of the one or more categories, one or more scores corresponding to one or more selections made with respect to one or more sub-categories, to obtain a category score for each of the one or more categories;
multiplying each category score by a corresponding category weight; and
summing the weighted category scores to obtain the rigor score.

8. The computer system of claim 1, wherein the memory stores additional computer-readable instructions that, when executed by the at least one processor, further cause the computer system to:
auto-populate one or more fields of an oversight worksheet file based on the determined rigor category and the calculated rigor score for the project,
wherein the oversight worksheet file is configured to track development and deployment of the project by measuring the project's satisfaction of one or more rigors, and
wherein the oversight worksheet file comprises the one or more deliverable checklists.

9. The computer system of claim 1, wherein the memory stores additional computer-readable instructions that, when executed by the at least one processor, further cause the computer system to:
receive user input via the one or more deliverable checklists; and
generate one or more compliance reports based on the user input received via the one or more deliverable checklists.

10. The computer system of claim 9, wherein the one or more compliance reports comprise status information for the project and the project's satisfaction of one or more rigors associated with the project.

11. A method, comprising:
at a computer system comprising at least one processor, at least one network interface for establishing communications between the computer system and one or more computing devices, and a memory storing computer-readable instructions that are executable by the processor:
receiving, by the computer system, an architectural assessment file, the architectural assessment file comprising an evaluation of development and deployment needs of a new project provided by one or more project architects during an initial estimation phase of the project;
calculating, by the computer system, based on the architectural assessment file, an architecture assessment score for the project;
selecting, by the computer system, based on the calculated architecture assessment score, an architectural engagement model to be imposed on the project at the initial estimation phase of the project,
wherein a first architectural engagement model is selected at the initial estimation phase when the calculated architecture assessment score is less than a predetermined architecture threshold, and
wherein a second architectural engagement model is selected at the initial estimation phase when the calculated architecture assessment score is greater than or equal to the architecture threshold;
receiving, by the computer system, a rigor worksheet file, the rigor worksheet file comprising an evaluation of risks and impact of the project provided by one or more members of a project team associated with the project during the initial estimation phase of the project;
calculating, by the computer system, based on the rigor worksheet file, a rigor score for the project;
determining, by the computer system, based on the calculated rigor score, a rigor category for the project;
selecting, by the computer system, based on the determined rigor category, one or more project deliverables to be imposed on the project at the initial estimation phase of the project;
generating, by the computer system, one or more deliverable checklists based on the one or more project deliverables selected to be imposed on the project at the initial estimation phase of the project;
storing, by the computer system, using the at least one network interface, the one or more deliverable checklists in a database associated with an enterprise file management system provided by at least one computing device different from the computer system; and
publishing, by the computer system, the one or more deliverable checklists by electronically transmitting one or more links to the one or more deliverable checklists to one or more entities.

12. The method of claim 11, wherein the architectural assessment file takes into account one or more project complexity factors and one or more customer impact factors.

13. The method of claim 11, wherein the rigor worksheet file takes into account one or more project cost factors, one or more project complexity factors, one or more customer impact factors, one or more risk factors, and one or more project benefit factors.

14. The method of claim 11, further comprising:
receiving, by the computer system, a revised architectural assessment file, the revised architectural assessment file comprising an evaluation of development and deployment needs of the project provided by one or more project architects during an analyze phase of the project, wherein the initial estimation phase of the project precedes the analyze phase of the project;
calculating, by the computer system, based on the revised architectural assessment file, a revised architecture assessment score for the project;
determining, by the computer system, based on the revised architecture assessment score, whether to continue to impose the previously selected architectural engagement model;
receiving, by the computer system, a revised rigor worksheet file, the revised rigor worksheet file comprising an evaluation of risks and impact of the project provided by one or more members of a project team associated with the project during the analyze phase of the project;
calculating, by the computer system, based on the revised rigor worksheet file, a revised rigor score for the project;
determining, by the computer system, based on the revised rigor score, a revised rigor category for the project; and
determining, by the computer system, based on the revised rigor category, whether to continue to impose the one or more previously selected project deliverables.

15. The method of claim 11, wherein the rigor score represents an objective measure of risk associated with the project.

16. The method of claim 11, further comprising:
receiving, by the computer system, an oversight worksheet file for the project at each phase of the project after the initial estimation phase; and
determining, by the computer system, based on the oversight worksheet file, whether the one or more selected project deliverables have been satisfied for a current phase of the project.

17. The method of claim 11,
wherein the architectural assessment file comprises one or more categories, and
wherein calculating the architecture assessment score for the project comprises:
adding, for each of the one of more categories, one or more scores corresponding to one or more selections made with respect to one or more sub-categories, to obtain a category score for each of the one or more categories;
multiplying each category score by a corresponding category weight; and
summing the weighted category scores to obtain the architecture assessment score.

18. The method of claim 11, further comprising:
auto-populating, by the computer system, one or more fields of an oversight worksheet file based on the determined rigor category and the calculated rigor score for the project,
wherein the oversight worksheet file is configured to track development and deployment of the project by measuring the project's satisfaction of one or more rigors, and
wherein the oversight worksheet file comprises the one or more deliverable checklists.

19. The method of claim 11, further comprising:
receiving, by the computer system, user input via the one or more deliverable checklists; and
generating, by the computer system, one or more compliance reports based on the user input received via the one or more deliverable checklists.

20. At least one non-transitory computer-readable medium having computer-executable instructions stored thereon that, when executed, cause a computer system comprising at least one processor, at least one network interface, and a memory to:
receive an architectural assessment file, the architectural assessment file comprising an evaluation of development and deployment needs of a new project provided by one or more project architects during an initial estimation phase of the project;
calculate, based on the architectural assessment file, an architecture assessment score for the project;
select, based on the calculated architecture assessment score, an architectural engagement model to be imposed on the project at the initial estimation phase of the project,
wherein a first architectural engagement model is selected at the initial estimation phase when the calculated architecture assessment score is less than a predetermined architecture threshold, and
wherein a second architectural engagement model is selected at the initial estimation phase when the calculated architecture assessment score is greater than or equal to the architecture threshold;
receive a rigor worksheet file, the rigor worksheet file comprising an evaluation of risks and impact of the project provided by one or more members of a project team associated with the project during the initial estimation phase of the project;
calculate, based on the rigor worksheet file, a rigor score for the project;
determine, based on the calculated rigor score, a rigor category for the project;
select, based on the determined rigor category, one or more project deliverables to be imposed on the project at the initial estimation phase of the project;
generate one or more deliverable checklists based on the one or more project deliverables selected to be imposed on the project at the initial estimation phase of the project;
store, using the at least one network interface, the one or more deliverable checklists in a database associated with an enterprise file management system provided by at least one computing device different from the computer system; and
publish the one or more deliverable checklists by electronically transmitting one or more links to the one or more deliverable checklists to one or more entities.
